(19) United States
(12) Patent Application Publication
(10) Pub. No.: US 2004/0227467 A1
(43) Pub. Date: Nov. 18, 2004

(54) Fluorescent lamp with compensation for ineffective luminance thereof

(76) Inventors: Hsin Tang Chien, Keelung City (TW); Jesan Chuang, Taipei City (TW)

Correspondence Address: BIRCH STEWART KOLASCH & BIRCH, PO BOX 747, FALLS CHURCH, VA, 22040-0747, US

(21) Appl. No.: 10/697,023

(22) Filed: Oct. 31, 2003

(30) Foreign Application Priority Data
May 13, 2003 (TW) 92208721

(51) Int. Cl. H01J 17/16; H01J 61/35

(52) U.S. Cl. 313/635; 313/110

(57) ABSTRACT

A fluorescent lamp with compensation for ineffective luminance thereof, including a lamp tube; and a fluorescent layer incompletely coated on an inner surface of the lamp tube to define a first light-transmitting section at a middle portion of the lamp tube and a second light-transmitting section at two ends of the lamp tube, wherein the second light-transmitting section has an area larger than that of the light-transmitting section.

### BACKGROUND OF THE INVENTION

1. Field of the Invention

The present invention relates to a fluorescent lamp with compensation for ineffective luminance thereof. More particularly, it relates to a fluorescent lamp applied for an optical scanning apparatus.

2. Description of the Related Art

Optical scanning apparatuses, such as scanners, printers, photocopiers, fax machines, projectors and the like, each utilizes a light source to provide a sufficient luminance to light up a scanned object for providing an image sensor of a scanning module to possess the capability transferring light intensity to electric signal.

Please referring to FIG. 1 shows a luminance characteristic curve of a conventional fluorescent lamp 10. From FIG. 1, a conventional lamp 10 includes a lamp tube having a fluorescent layer 11 completely coated on an inner surface thereof, and a pair of electrodes (not shown) respectively disposed on two opposing ends of the lamp tube. The conventional lamp 10 transforms visible light depends on the fluorescent layer 11 after discharging.

The luminance at the middle portion of the conventional lamp 10 is always higher than that at both ends. Hence, when a picture or document sheet is scanned, the unbalanced illumination of the conventional lamp 10 causes the scanned image to be distorted and dimmed at its margins.

The luminance relatively becomes lower to a certain degree, and somehow will not be sufficient to be sensed. Meanwhile, we call the lower luminance as “ineffective luminance”. Shown in FIG. 1, accordingly the two ends of the conventional lamp 10 each has an insufficient luminance, if there is no other light source to compensate, and a range relating to each of the two opposing ends is called for “ineffective luminance segment”, which is identified as the numeral 40. The ineffective luminance segment 40 is therefore useless, and the industry tries to improve the conventional lamp 10 and provides means such as:

for lengthening the tube of the conventional lamp 10 to drag out available range thereof, at the same time, however, itself elongated disobeys a rule of microlization of modern technologies;

for providing a plurality of light supplementary sheets, which are used for reflecting light, the light supplementary sheets have different sizes and respectively correspond to a middle portion and both opposing ends of the tube for compensating unbalanced luminance thereof. Parts of the light supplementary sheets corresponding to the middle portion thereof have smaller sizes, and parts corresponding to the both opposing ends thereof have large sizes, and the ineffective luminance segment 40 of the tube can be compensated and balanced; and

for providing two small lamps respectively installed on the both opposing ends thereof for directly lighting up the ineffective luminance segment 40, and furthermore, including a reflection sheet with dark parts to prevent the conventional lamp 10 from over bright at its both ends.

However, means for lengthening the tube of the conventional lamp 10 and means for providing two small lamps respectively installed on the both opposing ends thereof mentioned above both utilize including additional devices to compensate the ineffective luminance segment 40 thereof, however, sizes and volumes increasing with the additional devices is accompanied by extra manufacturing steps, time and costs, and low efficiency.

Hence, the prior art improved is required to overcome the disadvantages thereof.

### SUMMARY OF INVENTION

The object of the invention is therefore to specify a fluorescent lamp with compensation for ineffective luminance thereof to control various light-transmitting capacities relating to a middle portion and two opposing ends of a tube thereof, so as to compile a trend of microlization of modern technologies, and to avoid reducing efficiency and space utility by additional devices.

According to the invention, this object is achieved by a fluorescent lamp with compensation for ineffective luminance thereof, including a lamp tube; and a fluorescent layer incompletely coated on an inner surface of the lamp tube to define a light-transmitting section at a middle portion of the lamp tube and a second light-transmitting section at two ends of the lamp tube, wherein the second light-transmitting section is larger than the light-transmitting section.

To provide a further understanding of the invention, the following detailed description illustrates embodiments and examples of the invention. Examples of the more important features of the invention thus have been summarized rather broadly in order that the detailed description thereof that follows may be better understood, and in order that the contributions to the art may be appreciated. There are, of course, additional features of the invention that will be described hereinafter and which will form the subject of the claims appended hereto.

### BRIEF DESCRIPTION OF THE DRAWINGS

These and other features, aspects, and advantages of the present invention will become better understood with regard to the following description, appended claims, and accompanying drawings where:

FIG. 1 is a luminance characteristic curve of a conventional fluorescent straight-line lamp 10;

FIG. 2 is a top view of the present invention fluorescent lamp; and

FIG. 3 is a luminance characteristic curve of the present invention fluorescent lamp.

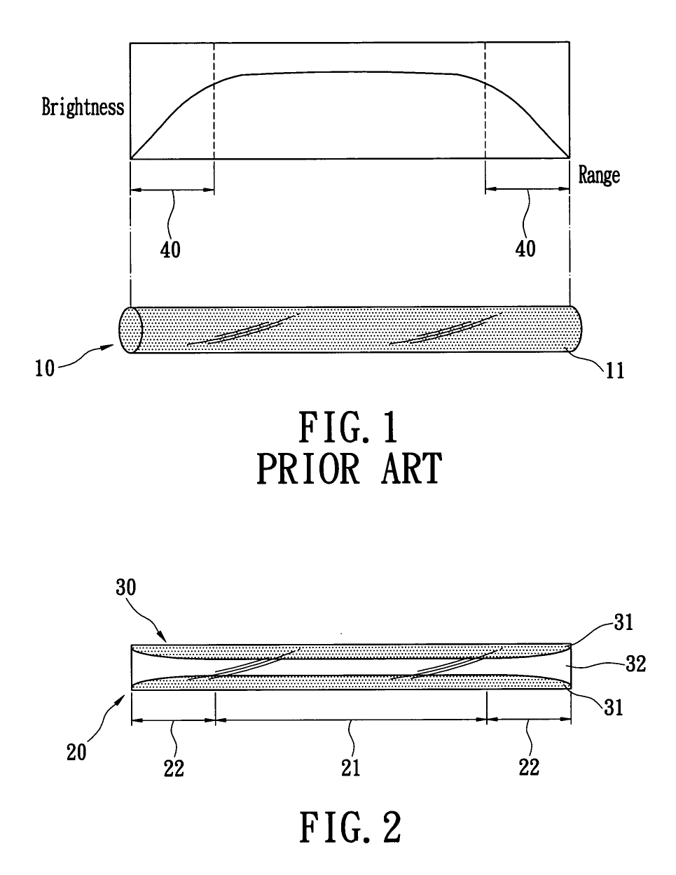

### DETAILED DESCRIPTION OF THE EMBODIMENTS

With respect to FIG. 2, shows a top view of the present invention fluorescent lamp 20 for compensating scanning luminance in an unavailable segment 40 thereof. The fluorescent lamp 20 includes a lamp tube; and a fluorescent layer 30 incompletely coated on an inner surface of the lamp tube to define a first light-transmitting section at a middle portion 21 of the lamp tube and a second light-transmitting section at each of two ends 22 of the lamp tube. Wherein the fluorescent layer 30 is gradually tapered from the middle portion 21 to the two ends 22 of the lamp tube, the fluorescent layer 30 is of two corresponding arc edges for defining the first light-transmitting section and the second light-transmitting section. The second light-transmitting section has an area larger than that of the first light-transmitting section, so as to the second light-transmitting section has a light-transmitting capacity larger than that of the first light-transmitting section.

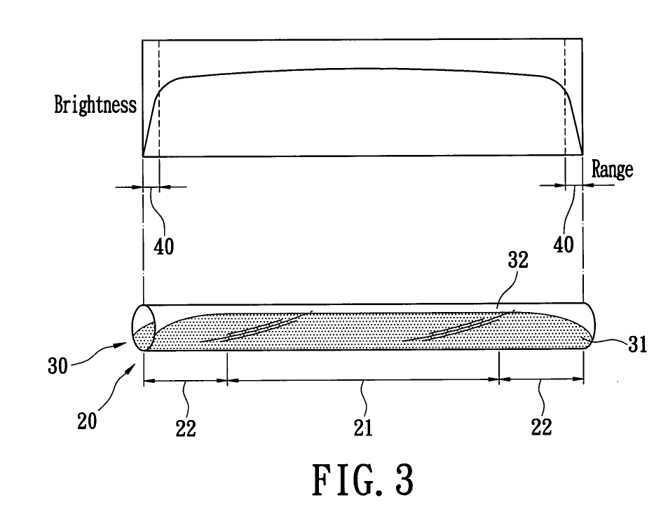

Referring to FIG. 3, shows a luminance characteristic curve of the present invention fluorescent lamp 20. The fluorescent lamp 20 utilizes a coating section 31 having a fluorescent layer 30 coated on a part of an inner surface of the lamp tube, which the coating section 31 is gradually tapered from a middle portion 21 to two ends 22 of the lamp tube, and a non-coating section 32 arranged at an opposite part of the inner surface of the lamp tube. Wherein the non-coating section 32 has an area at the two ends of the lamp tube larger than that of the coating section 31 for increasing the light-transmitting capacity at the two ends of the lamp tube. Therefore, the light-transmitting section segment 40 can be compensated and balanced by the distribution of fluorescent layer 30; there are no needs to lengthen the tube and to add extra devices, accordingly, the present invention will get less manufacturing steps, costs, and high efficiency.

It should be apparent to those skilled in the art that the above description is only illustrative of specific embodiments and examples of the invention. The invention should therefore cover various modifications and variations made to the herein-described structure and operations of the invention, provided they fall within the scope of the invention as defined in the following appended claims.

What is claimed is:

1. A fluorescent lamp with compensation for ineffective luminance thereof, comprising:
a lamp tube; and
a fluorescent layer incompletely coated on an inner surface of the lamp tube to define a first light-transmitting section at a middle portion of the lamp tube and a second light-transmitting section at two ends of the lamp tube;
whereby the second light-transmitting section has an area larger than that of the first light-transmitting section, the second light-transmitting section has a light-transmitting capacity lager than that of the light-transmitting section.

2. The fluorescent lamp of claim 1, wherein the fluorescent layer is of two corresponding arc edges for defining the first light-transmitting section and the second light-transmitting section.

3. A fluorescent lamp with compensation for ineffective luminance thereof, comprising:
a lamp tube;
a coating section including a fluorescent layer coated on a part of an inner surface of the lamp tube, and the coating section gradually tapered from a middle portion to two ends of the lamp tube; and
a non-coating section arranged at an opposite part of the inner surface of the lamp tube;
wherein the non-coating section has an area at the two ends of the lamp tube larger than that of the coating section for increasing a light-transmitting capacity.

4. The fluorescent lamp of claim 3, wherein the coating section has two sides each being of arc shape for controlling the light-transmitting capacity.
